(19) United States
(12) Patent Application Publication
(10) Pub. No.: US 2011/0128282 A1
(43) Pub. Date: Jun. 2, 2011

(54) Method for Generating the Depth of a Stereo Image

(75) Inventors: Chin-Yuan Wang, Tainan City (TW); Chia-Hang Ho, Taipei City (TW); Chun-Te Wu, Taoyuan City (TW); Wei-Jia Huang, Puli Township (TW); Kai-Che Liu, Kaohsiung City (TW)

(73) Assignee: INDUSTRIAL TECHNOLOGY RESEARCH INSTITUTE, Hsinchu (TW)

(21) Appl. No.: 12/780,074

(22) Filed: May 14, 2010

(30) Foreign Application Priority Data
Dec. 1, 2009 (TW) 98141004

(51) Int. Cl. G06T 15/00

(52) U.S. Cl. 345/419

(57) ABSTRACT

A method for generating image depth of a stereo image is provided. The method includes the following steps. Firstly, a stereo image is received. Next, a number of paths with greater gradient are searched in the stereo image. Then, the image depths of a number of first pixels in the paths are generated. After that, the image depths of a number of second pixels not in the paths are generated according to the image depths of the first pixels.

This application claims the benefit of Taiwan application Serial No. 98141004, filed Dec. 1, 2009, the subject matter of which is incorporated herein by reference.

### BACKGROUND

1. Technical Field

The disclosure relates in general to a method for generating image depth of a stereo image, and more particularly to a method for generating image depth of a stereo image through multiple paths with greater gradient.

2. Description of the Related Art

Currently, the belief propagation algorithm and the dynamic programming algorithm are commonly used in the stereo matching technology. Let the technology disclosed in United States Patent No. 2009/0129667 be taken for example. Despite the image depths obtained by the belief propagation algorithm is more accurate, a larger memory and a larger amount of computing time are required. Let the technology disclosed in U.S. Pat. No. 7,570,804 be taken for example. The dynamic programming algorithm has the advantages of requiring smaller memory and smaller amount of computing time. In the conventional method which computes the image depth by the dynamic programming algorithm, the entire scan line (single column or single row) is optimized. However, when such method is used, streak noise would easily occur in the depth chart (for example, low grey value denotes the image of shallow depth, and high grey value denotes the image of deep depth. If a three-dimensional image is generated according to the depth chart and a two-dimensional image, cracking may easily occur to the edge of the object in the three-dimensional image being obtained, hence deteriorating the quality of the three-dimensional image.

Thus, how to resolve the above problems so as to generate more accurate image depth, and increase the quality of the three-dimensional image generated according to the image depth has become an imminent issue to the manufacturers.

### SUMMARY

The disclosure is directed to a method for generating image depth of a stereo image.

According to an aspect of the present disclosure, a method for generating image depth of a stereo image is provided. The method includes the following steps. Firstly, a stereo image is received. Next, a number of paths with greater gradient are searched in the stereo image. Then, the image depths of a number of first pixels in the paths are generated. After that, the image depths of a number of second pixels not in the paths are generated according to the image depths of the first pixels.

The disclosure will become apparent from the following detailed description of the non-limiting embodiments. The following description is made with reference to the accompanying drawings.

### BRIEF DESCRIPTION OF THE DRAWINGS

FIG. 1 is a flowchart of a method for generating image depth of a stereo image according to an embodiment of the disclosure;

FIGS. 2A˜2D is schematic diagrams which show an example of obtaining a path by the greedy algorithm;

FIG. 3 is a diagram showing multiple paths; and

FIG. 4 is a block diagram of a system used for performing the method for generating image depth of a stereo image of FIG. 1.

### DETAILED DESCRIPTION

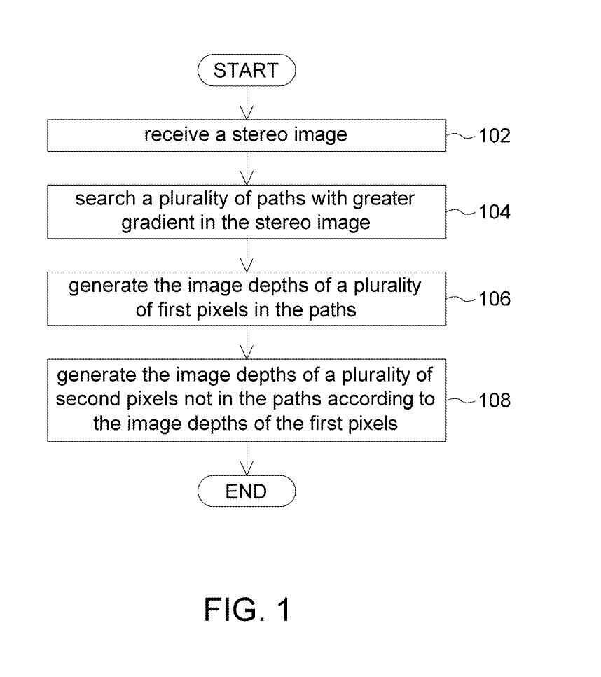

Referring to FIG. 1, a flowchart of a method for generating image depth of a stereo image according to an embodiment of the disclosure is shown. The method disclosed in the present embodiment of the disclosure includes the following steps. Firstly, the method begins at step 102, a stereo image is received. Next, the method proceeds to step 104, multiple paths with greater gradient are searched in the stereo image. Then, the method proceeds to step 106, multiple image depths of the first pixels in the paths are generated. After that, the method proceeds to step 108, according to the image depths of the first pixels, multiple image depths of the second pixels not in the paths are generated.

The multiple paths with greater gradient preferably are paths with greater color change. After analyzing the image depth generated by the conventional method, it is found that in the conventional method, the depths are more likely to be wrongly calculated in the region with smaller color change, and the calculation method using one row or one column as a unit tends to produce streak noise in the depth chart. Thus, in the present embodiment of the disclosure, paths with greater gradient such as paths with greater color change are searched in the image first, and then the depths of the image are calculated afterwards. After that, other pixel depths of the image are calculated by using other algorithms.

The depths of the pixels obtained in the paths with greater color change have higher accuracy. The accuracy of the depths of image is increased if multiple depths of the pixels in paths with higher accuracy are obtained first and then the depths of the pixels not in the paths are obtained next. Thus, the occurrence of streak noise in the depths is effectively reduced, and the quality of the three-dimensional image generated according to the depth is increased.

The steps of FIG. 1 are further elaborated below. In step 102, the stereo image being received such as includes a left-eye two-dimensional image and a right-eye two-dimensional image. In the present embodiment of the disclosure, multiple paths with greater gradient can be searched according to one of the left-eye two-dimensional image and the right-eye two-dimensional image. In step 104, the paths with greater gradient can be obtained by using the greedy algorithm or the dynamic programming algorithm, but the disclosure is not limited thereto.

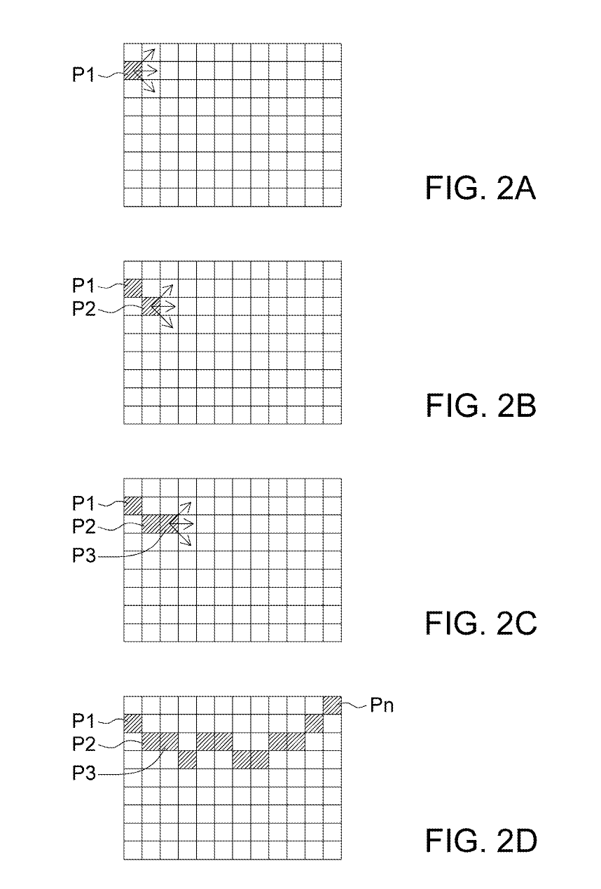

Referring to FIGS. 2A˜2D, an example of obtaining a path by the greedy algorithm is shown. As indicated in FIG. 2A, let the starting point of the path be pixel P1. In the pixels of the next column, the three pixels adjacent to the pixel P1 are candidate points as indicated by arrow. Of the three candidate points, the pixel whose color or grey value differs with the pixel P1 most is selected as the second pixel in the path. The selected pixel P2 is indicated in FIG. 2B. Then, of the three pixels adjacent to the pixel P2, the pixel whose color or grey value differs with the pixel P2 most is selected as the third pixel in the path as indicated in FIG. 2C. The above step is repeated so as to obtain n points in the path as indicated in FIG. 2D. Thus, a path L1 composed of P1, P2 . . . Pn is obtained.

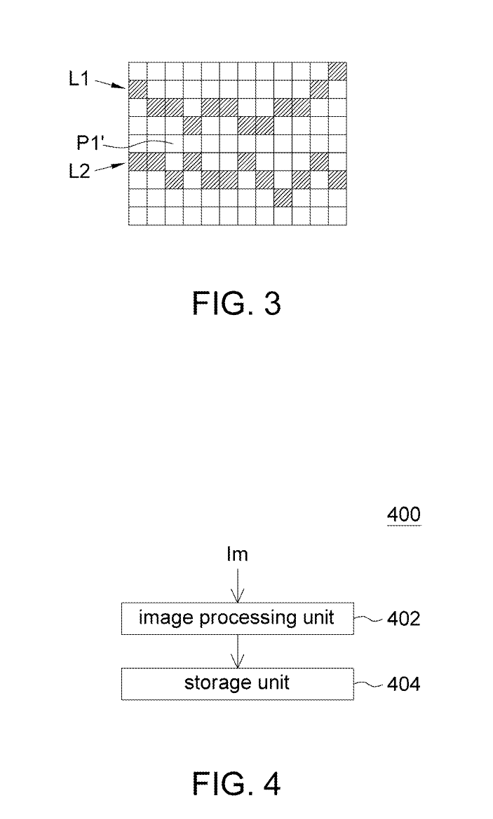

Another path L2 as indicated in FIG. 3 is obtained by repeating FIGS. 2A˜2D. Other paths (illustrated in the diagram) are obtained by repeating FIGS. 2A˜2D.

The detailed steps of searching a path by the dynamic programming algorithm are disclosed below. Firstly, the energy function e1 of each pixel in an image is defined as:

$${e}_{1} ( I ) = \vert \frac{\partial }{\partial x} I \vert + \vert \frac{\partial }{\partial y} I \vert$$

“I” denotes the brightness value of the pixel.

The path s^{y} is defined as:

s^{y}={sⱼ^{y}}ⱼ₌₁^{m}={(j,y(j))}ⱼ₌₁^{m},s,t,∪j|y(j)−y(j−1)|≦1.

(j, y (j)) denotes the coordinates of pixels in the paths, and m denotes the number of pixels included in one row of an image.

According to the above definition it is understood that for two pixels adjacent in the x coordinate of a path, the difference in the y coordinate is within one pixel.

However, the path to be searched in the present embodiment of the disclosure is the path with the smallest sum of the energy of all pixels, and must be conformed to the following expression of s*:

$${s}^{*} = {max}_{s} E ( s ) = {max}_{s} {\sum }_{j = 1}^{m} e ( I ( {s}_{j} ) )$$

To search for s*, an accumulative energy function M (i, j) is defined as:

M(i,j)=e(i,j)+max(M(i−1,j−1),M(i−1,j),M(i−1,j+1))

The maximum value of M (i, j) can be searched by using the dynamic programming algorithm, so as to obtain the entire path with largest energy by inference.

For more information about the dynamic programming algorithm, please refer to “Seam Carving For Content-Aware Image Resizing” by Avidan, S. and Shamir A. 2007 as well as the papers such as ACM SIGGRAPH 2007 (San Diego, Calif., Aug. 5-09, 2007) and SIGGRAPH '07. ACM, New York, N.Y., 10.

Then, in step 106 of FIG. 1, the image depths of the first pixels in the paths are preferably obtained by the dynamic programming algorithm. The energy function of the dynamic programming algorithm such as includes a matching cost function and a penalty function.

Furthermore, in the determination of the image depth in step 106, the present embodiment of the disclosure uses the following energy function:

$${E}_{path} ( d ( x , y ) ) = {\sum }_{( x , y ) ∈ {S}^{*}} C ( x , y , d ( x , y ) ) + {\sum }_{( x , y ) ∈ {S}^{*}} λ ( x , y ) ρ ( d ( x , y ) ) - d ( x + 1 , {y}_{x + 1} ) )$$

C(x, y, d(x,y)) denotes the matching cost when the disparity of the pixel (x,y) equals d(x,y). λ(x,y), ρ(d) are penalty functions arbitrarily defined.

If s* is one of the paths searched in step 104, then (x, y), (x+1, yₓ₊₁) are the pixels in the path s*.

Assuming:

C(x,y,d(x,y))=|I_{Left}(x,y)−I_{Right}(x+d,y)|

λ(x,y)=k

ρ(d)=|d|

I_{Left} (x, y) and I_{Right} (x, y) respectively denote the brightness values of the left-eye image pixel (x, y) and the right-eye image pixel (x, y), k is a given constant.

Similarly, Eₚₐₜₕ is minimized by using the dynamic programming algorithm so as to obtain the image depths corresponding to all pixels in the path s*.

In step 108 of FIG. 1, multiple image depths of the second pixels not in the paths can be generated by using the bilateral filter or by using the dynamic programming algorithm. The second pixel is such as the pixel P1′ of FIG. 3. The method of generating the image depths by using the bilateral filter is disclosed below.

The bilateral filter is a low-pass filter which maintains the details of image edge. In the present embodiment of the disclosure, the bilateral filter is used for generating the depth values of the pixels not in the paths of the depth chart so as to produce a high-quality depth chart.

The discrete mathematical model of the bilateral filter is expressed as:

$${I}_{pf} = \frac{1}{{K}_{p}} {\sum }_{q ∈ Ω} {G}_{s} ( p , q ) \cdot {G}_{r} ( {I}_{p} , {I}_{q} ) \cdot {I}_{p}$$

$${K}_{p} = {\sum }_{q ∈ Ω} {G}_{s} ( p , q ) \cdot {G}_{r} ( {I}_{p} , {I}_{q} )$$

p denotes the pixel to which filter processing is performed, and Ω denotes a mask range centered at p; q denotes the pixels within the Ω range, and I_{pf} denotes the color of the filtered pixel; Iₚ and I_{q} respectively denote the colors of pixels p and q; Gs and Gr denote two low-pass filters, the former functions in the pixel space, and the latter functions in the color space.

In practical application, as the bilateral filter cannot be divided according to dimensionality like the Gaussian low-pass filter, to instantly produce a depth chart, the present embodiment of the disclosure uses “Real-Time Edge-Aware Image Processing With The Bilateral Grid” disclosed by Chen, J., Paris, S., and Durand, F. 2007 as well as the method of bilateral grid disclosed in ACM SIGGRAPH 2007 (San Diego, Calif., Aug. 5-9, 2007).

Bilateral grid is a data structure which maps a two-dimensional image onto a three-dimensional space grid, wherein the mapping function is expressed as:

$$\{ \begin{matrix}x = ⌊ u / s ⌋ \\ y = ⌊ v / s ⌋ \\ z = ⌊ I ( u , v ) / r ⌋\end{matrix}$$

r and s denote two adjustable parameters; (u, v) denotes the coordinates of pixels in a two-dimensional image; I (u, v) denotes the brightness value of pixel (u, v); (x, y, z) denotes the pixel coordinate after the pixel (u, v) is mapped into the three-dimensional space grid.

Four values (r, g, b, n) are stored in each grid, wherein (r, g, b) denotes the sum of colors of the pixels mapped into the grid, and n denotes the number of pixels mapped into the grid.

After mapping a two-dimensional image into a three-dimensional space grid, ordinary low-pass filtering is performed to the values stored in the grid, and then the filtered values are mapped into the original image. By doing so, the low-frequency is blurred but the edge details are maintained.

When applying the bilateral grid to generate the part not in the paths of the depth chart, in order to copy the details of an object in a source image to the background of the initial depth chart, the mask range must be large enough such as covers 1/36˜¼ of the image. In practical application, the I (u, v) of the mapping function uses the brightness value of the source image, but the values stored in the grid are changed to (d, n), wherein d denotes the sum of depth estimates of all pixels mapped into the grid, and n also denotes the number of pixels mapped into the grid.

After the three-dimensional grid is created, low-pass filtering is performed to the grid, and then the filtered values are mapped into the depth chart. The experimental results show that after the bilateral grid is performed to the background of the depth hart which is originally smooth and not accurate, the object in the front view can be clearly separated from the background.

Apart from the bilateral filter, the unknown depths of remaining multiple second pixels can be obtained by using the dynamic programming algorithm. In the present embodiment of the disclosure, the unknown depths of remaining multiple second pixels can be compensated by scan line optimization utilized in conventional method. The depths of multiple second pixels not in the paths can be obtained according to the depths of multiple first pixels in the paths obtained in the step 106. Multiple image depths of the second pixels are calculated along the row direction or along the column direction.

Besides, in the bilateral filter, bilateral filtering is parallelly performing by dividing the stereo image into a number of blocks and using each block which is treated as an operation unit to save computing time and parallelly doing the operation on each block.

The disclosure provides a system used for performing the method for generating image depth of a stereo image of FIG. 1, wherein the block diagram of the system is indicated in FIG. 4. The system 400 includes an image processing unit 402 and a storage unit 404. The image processing unit 402 is for receiving the stereo image Im and performing the steps 102˜108 of FIG. 1, and the storage unit 404 is for storing the image depths of the stereo image Im and the first pixels and the second pixels.

The method for generating image depth of a stereo image disclosed in the above embodiments of the disclosure increases the accuracy of image depth and is conducive to enhancing the quality of subsequent three-dimensional image.

While the disclosure has been described by way of example and in terms of an exemplary embodiment, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for generating image depth of a stereo image, comprising:
receiving a stereo image;
searching a plurality of paths with greater gradient in the stereo image;
generating the image depths of a plurality of first pixels in the paths; and
generating the image depths of a plurality of second pixels not in the paths according to the image depths of the first pixels.

2. The method according to claim 1, wherein the paths with greater gradient are obtained by using greedy algorithm.

3. The method according to claim 1, wherein the paths with greater gradient are obtained by using dynamic programming algorithm.

4. The method according to claim 1, wherein in the step of generating the image depths of the first pixels, the image depths of the first pixels are obtained by using dynamic programming algorithm.

5. The method according to claim 4, wherein the energy function of the dynamic programming algorithm comprises a matching cost function and a penalty function.

6. The method according to claim 1, wherein the paths with greater gradient are paths with greater color change.

7. The method according to claim 1, wherein the image depths of the second pixels are generated by using bilateral filter to perform bilateral filtering.

8. The method according to claim 7, wherein bilateral filtering is performed by dividing the stereo image into a plurality of blocks and parallelly doing the operation on each block.

9. The method according to claim 1, wherein the image depths of the second pixels are generated by using dynamic programming algorithm.

10. The method according to claim 9, wherein the image depths of the second pixels are calculated along the row direction.

11. The method according to claim 9, wherein the image depths of the second pixels are calculated along the column direction.

12. The method according to claim 1, wherein the paths with greater gradient are paths with greater color change, the image depths of the first pixels are obtained by using dynamic programming algorithm, and the image depths of the second pixels are generated by using bilateral filter.

13. The method according to claim 1, wherein the paths with greater gradient are paths with greater color change, the image depths of the first pixels are obtained by using dynamic programming algorithm, and the image depths of the second pixels are generated by using dynamic programming algorithm.

14. A system for generating image depth of a stereo image, comprising:
an image processing unit for receiving a stereo image, searching a plurality of paths with greater gradient in the stereo image, generating the image depths of a plurality of first pixels in the paths, and generating the image depths of a plurality of second pixels not in the paths according to the image depths of the first pixels; and
a storage unit for storing the image depths of the stereo image, the first pixels and the second pixels.

15. The system according to claim 14, wherein the paths with greater gradient are obtained by using greedy algorithm.

16. The system according to claim 14, wherein the paths with greater gradient are obtained by using dynamic programming algorithm.

17. The system according to claim 14, wherein the image depths of the first pixels are obtained by using dynamic programming algorithm.

18. The system according to claim 14, wherein the paths with greater gradient are paths with greater color change.

19. The system according to claim 14, wherein the image depths of the second pixels are generated by using bilateral filter.

20. The system according to claim 14, wherein the image depths of the second pixels are generated by using dynamic programming algorithm.
